(19) United States
(12) Patent Application Publication
(10) Pub. No.: US 2026/0023811 A1
(43) Pub. Date: Jan. 22, 2026

(54) EXPRESSIVE SPARSE MATRIX REPRESENTATIONS WITH LIMITED METADATA

(71) Applicant: NVIDIA Corporation, Santa Clara, CA (US)

(72) Inventors: Jeffrey Michael Pool, Chapel Hill, NC (US); Manan Patel, San Jose, CA (US); Ming Yiu Siu, Sammamish, WA (US); Po-An Tsai, Somerville, MA (US)

(21) Appl. No.: 18/777,367

(22) Filed: Jul. 18, 2024

(51) Int. Cl. G06F 17/16

(52) U.S. Cl. CPC G06F 17/16

(57) ABSTRACT

Disclosed are systems and techniques for compressing a dense matrix into an expressive sparse matrix representation with limited metadata. The techniques include generating a sparse matrix with corresponding metadata based on a dense matrix. Generating the sparse matrix with corresponding metadata includes identifying a first number (M) of elements to compress, a second number (N) of elements to retain, a third number (P) of positions, and a format; determining a metadata value for each of N elements of the dense matrix based on the identified P and the identified format, wherein the dense matrix includes at least M elements; and generating the sparse matrix containing the N elements of the dense matrix. The techniques include storing the sparse matrix and the corresponding metadata, wherein the corresponding metadata comprises the metadata value for each of the N elements of the dense matrix.

### TECHNICAL FIELD

At least one embodiment pertains to a system for compressing a dense matrix to create an expressive sparse matrix representation with limited metadata.

### BACKGROUND

Neural networks use a lot of matrix math operations (e.g., matrix multiply, dot product, etc.) during training and during inference. For example, the weights of a layer of a neural network can be stored in a matrix. To compute the output values of a layer, the weights of the layer may be multiplied by the input values to the layer. In some cases, setting some of the weights to zero does not have a significant impact on the result of the neural network. Weights with zero values do not need to be considered during matrix multiply operations because the result will always be zero, so the math throughput can be increased when there are more zero values in the matrix. A matrix can be compressed to preserve a subset of values (e.g., nonzero values) while discarding the remaining values (e.g., zero values) to reduce storage space requirements and to increase math operation throughput (since discarded values can be treated as zeros).

### BRIEF DESCRIPTION OF THE DRAWINGS

FIG. 1 is an example block diagram of a system capable of using expressive sparse matrices with limited metadata, according to at least one embodiment;

FIG. 2 is example block diagrams of compressing a dense matrix to an expressive sparse matrix with limited metadata, according to at least one embodiment;

FIG. 3 is example block diagrams of decompressing an expressive sparse matrix with limited metadata to an uncompressed matrix, according to at least one embodiment;

FIG. 4A is an example block diagram of decompressing an expressive sparse matrix with limited metadata to an uncompressed matrix, according to at least one embodiment;

FIG. 4B is an example block diagram of decompressing an expressive sparse matrix with limited metadata to an uncompressed matrix, according to at least one embodiment;

FIG. 4C is an example block diagram of decompressing an expressive sparse matrix with limited metadata to an uncompressed matrix, according to at least one embodiment;

FIG. 4D is an example block diagram of decompressing an expressive sparse matrix with limited metadata to an uncompressed matrix, according to at least one embodiment;

FIG. 5A is an example block diagram of compressing a dense matrix to a fully-expressive sparse matrix with limited metadata, according to at least one embodiment;

FIG. 5B is an example block diagram of decompressing a fully-expressive sparse matrix with limited metadata to an uncompressed matrix, according to at least one embodiment;

FIG. 6 is an example block diagram of computing a dot-product between a sparse matrix with corresponding metadata and a matrix operand, according to at least one embodiment;

FIG. 7 is an example block diagram of an integrated circuit for performing matrix math operations using a sparse matrix with corresponding metadata, according to at least one embodiment;

FIG. 8 is a flow diagram of an example method for compressing a dense matrix to an expressive sparse matrix with limited metadata, according to at least one embodiment;

FIG. 9 is a flow diagram of an example method for decompressing an expressive sparse matrix with limited metadata to an uncompressed matrix, according to at least one embodiment;

FIG. 10 is a flow diagram of an example method for computing a dot product using an expressive sparse matrix with limited metadata, according to at least one embodiment;

FIG. 11 is a flow diagram of an example method for performing matrix multiply operations using an expressive sparse matrix with limited metadata, according to at least one embodiment;

FIG. 12 is a flow diagram of an example method for compressing a dense matrix to a fully-expressive sparse matrix with limited metadata, according to at least one embodiment.

### DETAILED DESCRIPTION

Some values of a matrix may be more important than other values for a given task. By removing less important values of the matrix (e.g., converting a dense matrix to a sparse matrix), math throughput can be improved. Existing sparse matrix representations preserve N nonzero values out of M consecutive elements of the dense matrix (N:M sparsity). For example, a 2:4 sparse matrix would have 2 nonzero values of each consecutive set of 4 elements of the dense matrix, and a 4:8 sparse matrix would have 4 nonzero values of each consecutive set of 8 elements of the dense matrix. Metadata can be used to indicate the indices of each nonzero value (or, in some instances, indices of each zero value). As an example, a 2:4 sparse matrix would require 2 bits of metadata per nonzero to represent all possible compressed matrices, and a 4:8 sparse matrix would require 3 bits of metadata per nonzero to represent all possible compressed matrices. It can be advantageous to store less metadata, however, less metadata means that fewer dense matrices can be expressed by a sparse matrix.

The present disclosure provides for systems and techniques that allow for expressive sparse matrix representations with limited (e.g., constrained amounts of) metadata. An expressive sparse matrix representation can allow N nonzero values out of M consecutive elements of a dense matrix where each nonzero has P available positions interpreted according to a given format F (N:M:P,F sparsity). N:M sparse matrices (discussed above) are equivalent to N:M:P,full sparse matrices (e.g., where P=M). For example, the 4:8 sparse matrix discussed above allows 4 nonzero values out of 8 consecutive elements, and each nonzero value can be in any of the 8 available positions. This could be represented as a 4:8:8, full sparse matrix. This allows representing any of 70 different data patterns

$$( e . g . , Combination ( 8 , 4 ) = \frac{8 !}{( 4 ! ( 8 - 4 ) ! )} = 70 ) ,$$

but it requires 3 bits of metadata to indicate the index of each nonzero value (e.g., log₂(8)=3).

By selecting a P<M, the amount of metadata required to indicate the index of each nonzero value can be reduced. For example, a 4:8:4 sparse matrix only requires 2 bits of metadata to indicate the index of each nonzero value (since each nonzero can only be in one of 4 positions (e.g., log₂(4)=2) instead of one of 8 positions). The number of data patterns that can be expressed using an N:M:P sparse matrix depends on the selected format F. For example, using a simple “replicated” format, 36 data patterns can be represented using a 4:8:4 sparse matrix. Using a “direct” format, the same 4:8:4 sparse matrix can represent 60 different data patterns. Using a “checkerboard” format, the same 4:8:4 sparse matrix can represent 66 different data patterns. Thus, a 4:8:4, checkerboard sparse matrix can represent 94% of the data patterns that can be represented by a 4:8:8, full sparse matrix, but it requires only 2 bits of metadata per nonzero versus 3 bits of metadata per nonzero (a 33% space savings).

Compressing a dense matrix to a N:M:P,F sparse matrix can be performed using software or hardware. Compression of 8 elements into a 4:8:4 sparse matrix will be discussed, but it should be understood that N, M, and P can be any values such that N<M and P<M. Compression can begin by calculating an “importance” of each source element according to an importance criterion. For example, the “importance” of an element may be determined based on an absolute magnitude of the element. The goal of the compression can be to represent the 8 elements with the highest possible cumulative “importance,” that is, the sum of the importance of every nonzero element in the compressed representation of the data can be maximized.

The present disclosure also provides for systems and techniques that allow for fully-expressive sparse matrix representations with limited (e.g., constrained amounts of) metadata. A fully-expressive sparse matrix representation can allow N nonzero values out of M consecutive elements of a dense matrix using B bits of metadata (N:M:Bb sparsity). Traditional implementations can compress a dense matrix to a 4:8 sparse matrix where each nonzero has a corresponding 3-bit metadata value to express the index of the nonzero in the dense matrix. The disclosed techniques can compress a dense matrix to a 4:8:2b sparse matrix where each nonzero has a corresponding 2-bit metadata value (a 33% space savings) without losing any expressivity (e.g., all dense matrices that can be expressed using a 4:8 compression scheme with 3-bits of metadata can be expressed using the 4:8:2b compression scheme disclosed herein). By assigning special meaning to some combinations of metadata, the data patterns that cannot be expressed using a 4:8:4, checkerboard compression scheme can be expressed using the 4:8:2b compression scheme, leading to full expressivity.

The advantages of the disclosed techniques include but are not limited to reduced storage space requirements for storing sparse matrices versus their dense counterparts and additional computational throughput when the sparse matrices are used in matrix calculations.

### System Architecture

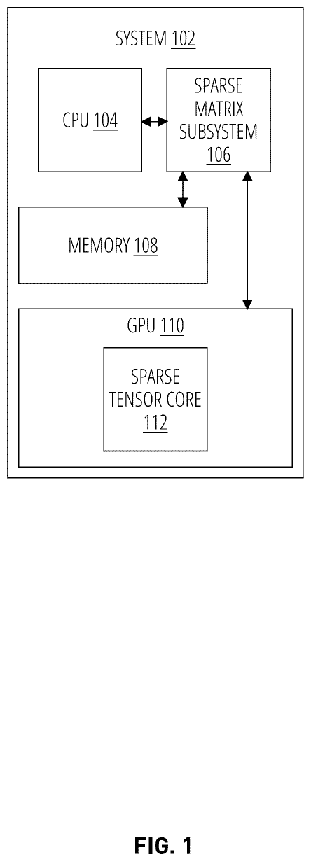

FIG. 1 is an example block diagram of a system 102 capable of using expressive sparse matrices with limited metadata, according to at least one embodiment. System 102 can include a central processing unit (CPU) 104, sparse matrix subsystem 106, memory 108, and graphics processing unit (GPU) 110. In some embodiments, memory 108 can store one or more matrices (or portions thereof) and sparse matrix metadata. For example, memory 108 can store a dense matrix, a sparse matrix representing a compressed form of the dense matrix, and metadata corresponding to the sparse matrix. In some embodiments, the dense matrix can be converted (e.g., compressed) to the sparse matrix with corresponding metadata by sparse matrix subsystem 106 of system 102. In some embodiments, sparse matrix subsystem 106 uses CPU 104 to compress a dense matrix (e.g., from memory 108) into a sparse matrix with corresponding metadata. In some embodiments, sparse matrix subsystem 106 uses GPU 110 to compress a dense matrix (e.g., from memory 108) into a sparse matrix with corresponding metadata. Sparse matrix subsystem 106 can store the resulting sparse matrix and corresponding metadata to memory 108.

In some embodiments, sparse matrix subsystem 106 can decompress a sparse matrix based on the corresponding metadata to obtain a decompressed matrix. The decompressed matrix can include a subset of the values of the original dense matrix from which the sparse matrix was generated. For example, if the original dense matrix included 8 elements, 6 of which were nonzero, and was compressed using a 4:8:4, F compression scheme, the decompressed matrix could include 4 of the 6 nonzero values of the dense matrix. 2 of the nonzero elements can be lost during the compression-decompression process because the 4:8:4, F compression scheme only stores 4 nonzero elements for a set of 8 consecutive elements.

GPU 110 can be used to perform parallel operations. For example, GPU 110 can be used to perform math computations in parallel. This can be advantageous when training and performing inference on an artificial intelligence (AI) model, such as a neural network. In some embodiments, GPU 110 can include one or more sparse tensor cores 112. Sparse tensor core 112 can include one or more integrated circuits for performing calculations (e.g., matrix math operations, matrix multiply operations) using sparse matrices and corresponding metadata. As an example, sparse tensor core 112 can be used to calculate the output values of a layer of a neural network using a sparse matrix representing weights of the layer of the neural network. Based on the metadata corresponding to the sparse matrix, sparse tensor core 112 can select values from a matrix operand and calculate a product (e.g., dot-product) between the sparse matrix and the subset of values from the matrix operand.

In some embodiments, it can be advantageous to compress a dense matrix into a sparse matrix even if it is not being used in sparse tensor core 112. For example, compressing a dense matrix into a sparse matrix can reduce storage space requirements (e.g., reducing the storage space required to store the weights of a neural network or other AI model). Similarly, bandwidth requirements for transmission of the matrix over a network are reduced if the dense matrix is first compressed to a sparse representation with corresponding metadata.

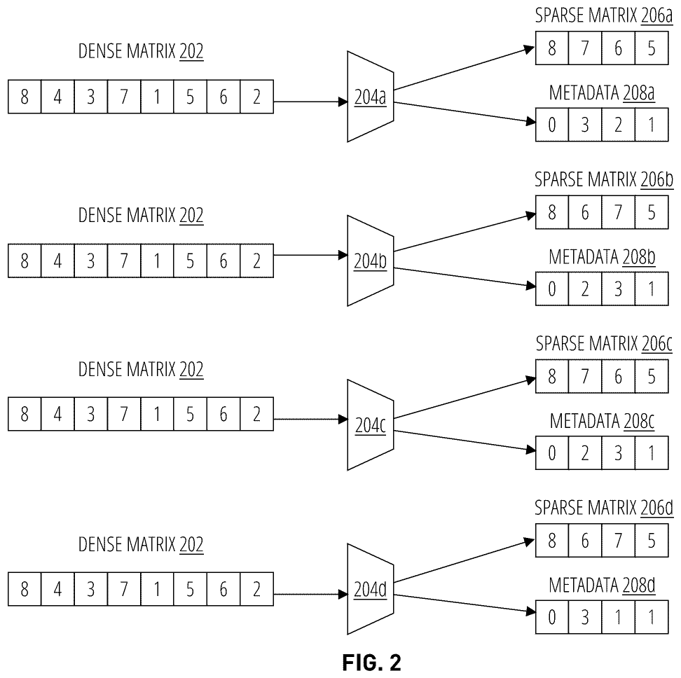

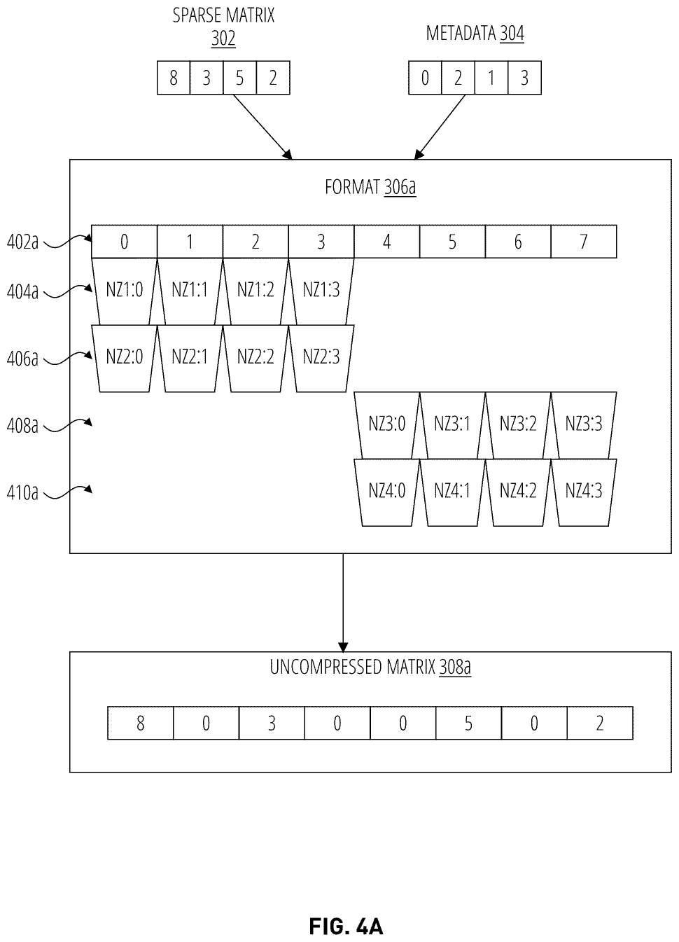

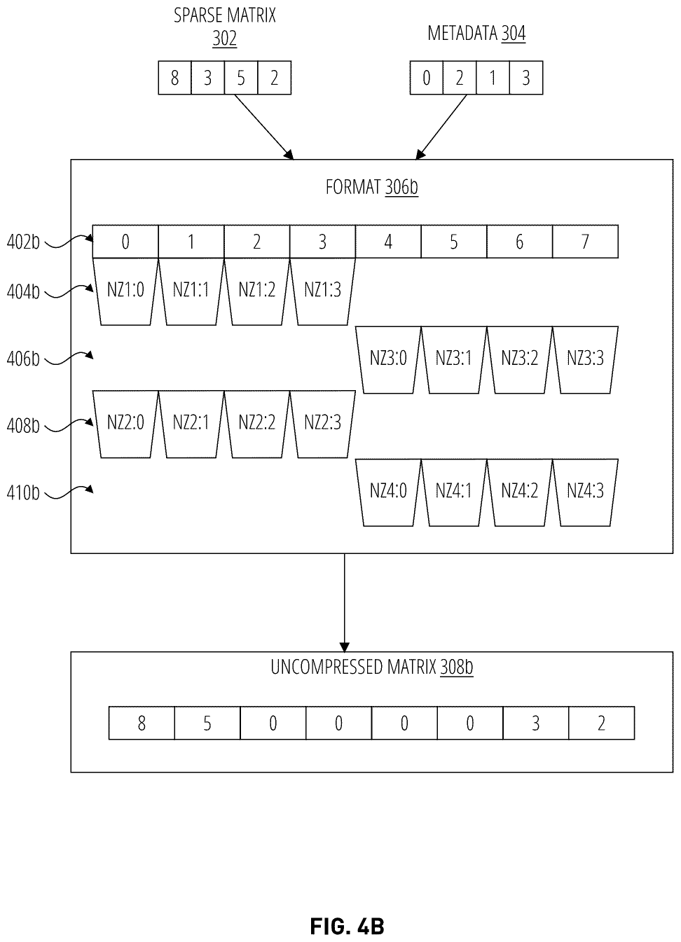

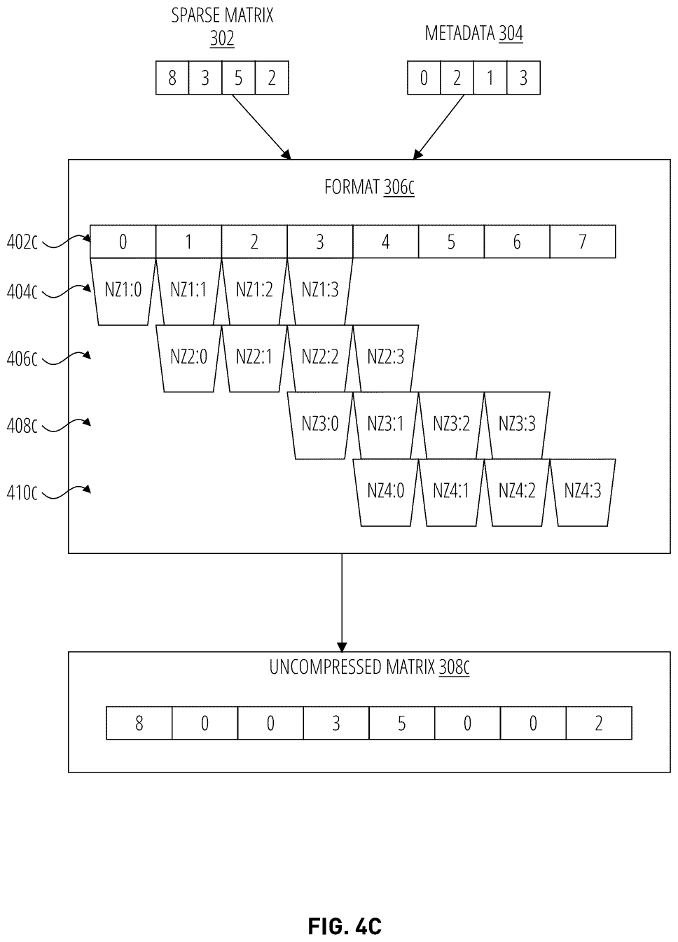

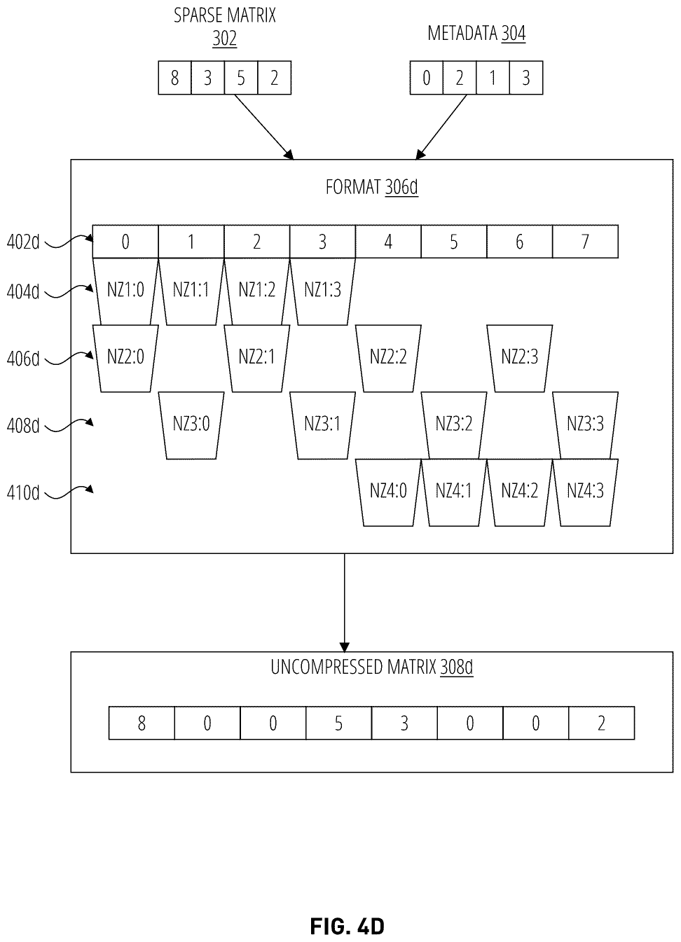

FIG. 2 is example block diagrams of compressing a dense matrix 202 to an expressive sparse matrix with limited metadata, according to at least one embodiment. A given dense matrix (e.g., dense matrix 202) can be compressed into various sparse matrix representations with corresponding metadata depending on the selected format for the compression. The selected compression scheme determines the size of the metadata. FIG. 2 shows dense matrix 202 being compressed using a 4:8:4, F compression scheme with 4 different formats: 204a, 204b, 204c, and 204d. For example, dense matrix 202 compressed using the 4:8:4, F compression scheme with format 204a results in sparse matrix 206a and metadata 208a. 4 nonzero elements of the 8 consecutive elements of dense matrix 202 are preserved in sparse matrix 206a. Each nonzero of sparse matrix 206a can be in one of four possible positions (since P=4 in the N:M:P,F compression scheme). Metadata 208a indicates an index of each nonzero within its corresponding 4 available positions. (Sec FIG. 4A, FIG. 4B, FIG. 4C, and/or FIG. 4D for examples of some possible formats and the available positions of each nonzero for that format).

Dense matrix 202 compressed using the 4:8:4, F compression scheme with format 204b results in sparse matrix 206b and corresponding metadata 208b. Dense matrix 202 compressed using the 4:8:4, F compression scheme with format 204c results in sparse matrix 206c and corresponding metadata 208c. Dense matrix 202 compressed using the 4:8:4, F compression scheme with format 204d results in sparse matrix 206d and corresponding metadata 208d.

The selected format determines the resulting sparse matrix and metadata. For example, sparse matrix 206a and sparse matrix 206c share the same values, but their corresponding metadata values (e.g., metadata 208a and metadata 208c, respectively) are different due to the different formats. Similarly, sparse matrix 206b and sparse matrix 206d share the same values, but their corresponding metadata values (e.g., metadata 208b and metadata 208d, respectively) are different. Although sparse matrix 206a, sparse matrix 206b, sparse matrix 206c, and sparse matrix 206d share the same values but in different orders in this example, it should not be understood that this will always be the case. In some cases, not all of the highest magnitude values can be represented in the compressed format, so different formats may result in different values of the dense matrix being included in the sparse matrix.

Although dense matrix 202 is shown with 8 integers, it should be understood that dense matrix 202 can include values (or elements) of any length. For example, dense matrix 202 can include 8 32-bit floating point numbers. After compression, the corresponding sparse matrix (e.g., sparse matrix 206a) can include 4 32-bit floating point numbers. The metadata corresponding to the sparse matrix (e.g., metadata 208a) can include 4 2-bit values representing an index of each of the 4 nonzeros within its corresponding 4 available positions.

As another example, a dense matrix can include 16 16-bit floating point numbers. If the dense matrix were compressed using a 6:16:8, F compression scheme, the resulting sparse matrix could include 6 16-bit floating point numbers and the corresponding metadata could include 6 3-bit values (e.g., log₂(8)=3) representing an index of each of the 6 nonzeros within its corresponding 8 available positions.

Although dense matrix 202 is shown with one row of elements (e.g., a 1×8 matrix), it should be understood that dense matrix 202 can include multiple rows of elements. For example, dense matrix 202 can be an 8×8 matrix and can be compressed into a 8×4 sparse matrix with a corresponding 8×4 matrix of metadata values. In some embodiments, each row of dense matrix 202 can be compressed using a different P and/or format. In some embodiments, each row of dense matrix 202 can be compressed using a different compression scheme, such as N:M:P,F for a first row and N:M:Bb for a second row. In some embodiments, subsets of a row of dense matrix 202 can be compressed individually. In some embodiments, the resulting sparse matrices can be joined (e.g., concatenated) together to make a single resulting sparse matrix. In some embodiments, elements of multiple rows of dense matrix 202 can be considered consecutive elements for compression.

To perform compression using the N:M:P,F scheme, a dense matrix can be received and/or identified. The dense matrix can include at least M consecutive elements. The dense matrix can have K nonzero elements. N of the M elements can be preserved during compression and can be included in the sparse matrix. The N elements of the resulting sparse matrix can be a subset of the K nonzero elements of the dense matrix. In some embodiments, the elements of the dense matrix that are not preserved in the sparse matrix are all zeros. In some embodiments, the elements of the dense matrix that are not preserved in the sparse matrix include at least one nonzero value.

The number of nonzero positions P and the format F of the N:M:P,F compression scheme used for compression determines how the dense matrix can be expressed in the sparse matrix and corresponding metadata. The goal of the compression can be to maximize the overall importance value (e.g., the sum of the importance values of each element) of the resulting sparse matrix. In some embodiments, all possible combinations of sparse matrix and metadata based on the nonzero positions P available in the determined format F can be evaluated and the overall importance of each resulting sparse matrix can be determined. The sparse matrix and metadata that results in the highest overall importance of the resulting matrix can then be selected as the result of the compression of the dense matrix. For example, an 8-element dense matrix compressed using a 4:8:4, checkerboard compression scheme can be compressed into 66 unique sparse matrix and metadata pairs. Each of the 66 unique pairs can be evaluated to determine which results in the highest overall importance value. However, in some embodiments (e.g., in a hardware implementation), it can be difficult and/or infeasible to evaluate all possible combinations. Additionally, since some P,F compression schemes have overlapping nonzero positions, the order of selecting/assigning nonzero values and corresponding metadata during compression can affect the overall importance of the resulting sparse matrix. In such cases, a compression sequence can be used to determine the resulting sparse matrix and metadata pair. The compression sequence can include importance comparison of the nonzero values and/or sorting of the nonzero values.

In some embodiments, a first compression sequence can include determining nonzero values and corresponding metadata values in a predefined order. For example, in a 4:8:4, checkerboard compression scheme, it can be advantageous to determine the first nonzero value and the fourth nonzero value with their corresponding metadata values before determining the second nonzero value and the third nonzero value with their corresponding metadata values. In other words, the importance values of all 8 elements of the dense matrix to compress (or only the importance values of all K nonzero elements of the dense matrix) can be determined. Then, the first sparse matrix value (and its corresponding metadata value) can be selected as the element with the maximum importance value among elements 0-3 of the dense matrix (since the available positions of the first nonzero in the “checkerboard” format cover elements 0-3 of the dense matrix) (See FIG. 4D for an example of the “checkerboard” format and the available nonzero positions corresponding to each nonzero).

Then, the fourth sparse matrix value (and its corresponding metadata value) can be selected as the element with the maximum importance value among elements 4-7 of the dense matrix (since the available positions of the fourth nonzero in the “checkerboard” format cover elements 4-7 of the dense matrix). The importance values of the selected first nonzero and the selected fourth nonzero can be cleared (e.g., set to 0 or some other minimum value).

Then, the second sparse matrix value (and its corresponding metadata value) can be selected as the element with the maximum importance value among elements 0, 2, 4, and 6 of the dense matrix, taking into account the importance values that were cleared after assigning the first and fourth nonzero values. The third sparse matrix value (and its corresponding metadata value) can be selected as the element with the maximum importance value among elements 1, 3, 5, and 7 of the dense matrix, taking into account the importance values that were cleared after assigning the first and fourth nonzero values. The resulting sparse matrix can include the 4 nonzero elements selected during their corresponding phases. In some embodiments, the overall importance value of the resulting sparse matrix determined according to this first compression sequence may not be maximized but the compression can be performed in a hardware efficient manner, resulting in an acceptable tradeoff.

In some embodiments, selecting one or more sparse matrix values can occur simultaneously. For example, the first sparse matrix value selected from elements 0-3 of the dense matrix may be selected while (e.g., concurrent with, simultaneously, etc.) the second sparse matrix value selected from elements 4-7 of the dense matrix is being selected. In some embodiments, selecting one or more sparse matrix values can occur in series.

In some embodiments, a second compression sequence can include sorting nonzero values by their importance value and assigning nonzeros in a predetermined order. As an example, to compress a dense matrix with 8-elements using a 4:8:4, checkerboard compression scheme according to the second compression sequence, an importance of all 8 elements of the dense matrix (or of the K nonzero elements of the dense matrix) can be determined. The elements can be sorted according to their importance values. The most important element can be assigned to the first compatible nonzero of the sparse matrix (e.g., the first nonzero with a nonzero position that covers the index of the element of the dense matrix). Then the next most important element can be assigned to the next compatible nonzero of the sparse matrix. This can continue until all nonzeros of the sparse matrix have been assigned.

In some embodiments, a third compression sequence can include sorting nonzero values by their importance value and selecting nonzero values based on which nonzero values are most constrained. Depending on the selected P,F compression scheme, a particular index of the dense matrix can be expressed using more than one of the available nonzero positions of the format F. For example, in the “4, checkerboard” compression scheme (see FIG. 4D), a nonzero in index 0 of the dense matrix can be expressed by nonzero 1 with a metadata value of 0 or by nonzero 2 with a metadata value of 0. As another example, in the same “4, checkerboard” compression scheme, a nonzero in index 3 of the dense matrix can be expressed by nonzero 1 with a metadata value of 3 or by nonzero 3 with a metadata value of 1. Because of this, the order of selecting nonzero elements can have an effect on the overall importance value of the resulting sparse matrix. It can be advantageous to select nonzero elements of the dense matrix based on how many ways the index of the nonzero element can be expressed in the sparse matrix and corresponding metadata.

As an example, to compress a dense matrix with 8-elements using a 4:8:4, checkerboard compression scheme according to the third compression sequence, an importance value of all 8 elements of the dense matrix (or of the K nonzero elements of the dense matrix) can be determined. Then a constraint value can be calculated for each element that indicates how many nonzeros can represent the index of that element. The element with the highest importance value and lowest constraint value (e.g., the most important and most constrained value) can be selected first and assigned to the constraining nonzero of the sparse matrix. The assigned nonzero can be removed as an option for the other elements of the dense matrix, and the constraint values can (optionally) be recalculated. The element with the next highest importance value and lowest constraint value can be selected second and assigned to the constraining nonzero. This can continue until all nonzeros of the sparse matrix have been assigned a value.

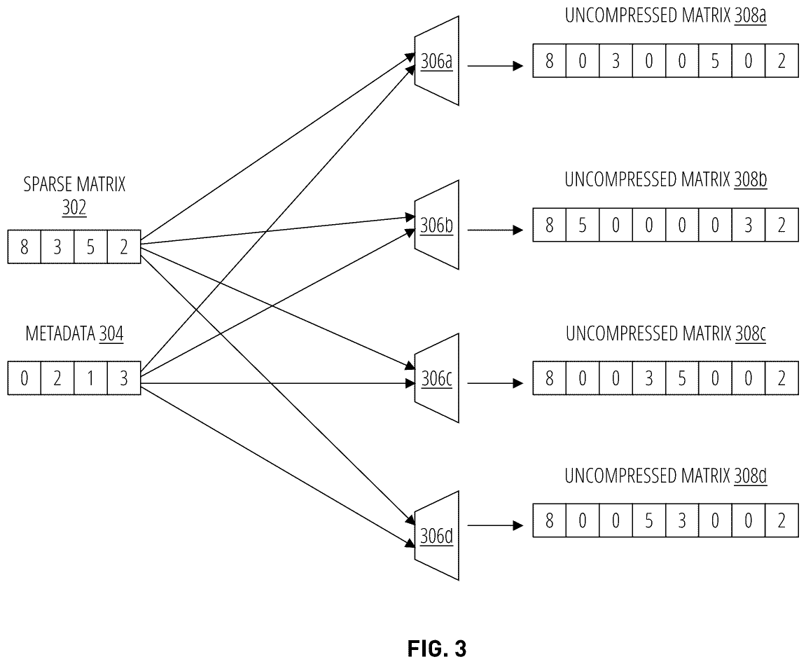

FIG. 3 is example block diagrams of decompressing an expressive sparse matrix 302 with limited metadata to an uncompressed matrix, according to at least one embodiment. A given sparse matrix (e.g., sparse matrix 302) and corresponding metadata (e.g., metadata 304) can be decompressed into various uncompressed matrices depending on the format selected during compression. FIG. 3 shows sparse matrix 302 and corresponding metadata 304 being decompressed using a 4:8:4, F (de) compression scheme with 4 different formats: 306a, 306b, 306c, and 306d. For example, sparse matrix 302 and corresponding metadata 304 decompressing using a 4:8:4, F scheme with format 306a results in uncompressed matrix 308a. The 4 nonzero elements of sparse matrix 302 are preserved in uncompressed matrix 308a. Based on metadata 304 and format 306a, the nonzero elements of sparse matrix 302 are assigned a position in uncompressed matrix 308a. In some embodiments, the other positions of uncompressed matrix 308a (e.g., those that do not correspond to a nonzero value from sparse matrix 302) can be assigned a zero value.

Sparse matrix 302 and metadata 304 can be decompressed using format 306b to obtain uncompressed matrix 308b. Sparse matrix 302 and metadata can be decompressed using format 306c to obtain uncompressed matrix 308c. Sparse matrix 302 and metadata 304 can be decompressed using format 306d to obtain uncompressed matrix 308d.

The format used during decompression determines the resulting uncompressed matrix. For example, sparse matrix 302 and metadata 304 can be decompressed into at least 4 different matrices (e.g., uncompressed matrix 308a, uncompressed matrix 308b, uncompressed matrix 308c, uncompressed matrix 308d) based on the selected format. Using the same format during compression and decompression can result in an uncompressed matrix that is similar to the original dense matrix. In other words, the uncompressed matrix can have a subset of values of the dense matrix in the same position as the corresponding values in the dense matrix if the sparse matrix is uncompressed using the same compression scheme and format that was used to compress the dense matrix.

FIG. 4A is an example block diagram of decompressing an expressive sparse matrix with limited metadata to an uncompressed matrix, according to at least one embodiment. Sparse matrix 302 and corresponding metadata 304 can be decompressed according to format 306a to obtain uncompressed matrix 308a. In some embodiments, format 306a can be known as a “replicated” format (e.g., N:M:P,replicated). Format 306a is represented with output indices 402a 0-7 and buckets corresponding to each of the possible positions for each nonzero of sparse matrix 302. For example, because format 306a corresponds to a 4:8:4, F (de) compression scheme, there are 4 rows of nonzero positions (e.g., 404a, 406a, 408a, and 410a) corresponding to the 4 nonzero elements of sparse matrix 302 (e.g., N=4 in N:M:P,F scheme). Each row of nonzero positions has 4 buckets corresponding to the 4 available positions for each nonzero (e.g., P=4 in N:M:P,F scheme).

Nonzero 1 positions 404a include 4 buckets indexed 0-3 each corresponding to an index of uncompressed matrix 308a: NZ1:0 corresponds to index 0, NZ1:1 corresponds to index 1, NZ1:2 corresponds to index 2, and NZ1:3 corresponds to index 3. Thus, based on the first index value in metadata 304, the first nonzero of sparse matrix 302 (e.g., 8) can end up at index 0, index 1, index 2, or index 3 of uncompressed matrix 308a. Because the first index value of metadata 304 is 0, the first nonzero of sparse matrix 302 (e.g., 8) is assigned to the 0th indexed bucket of nonzero 1 positions 404a and ends up at index 0 of uncompressed matrix 308a.

Nonzero 2 positions 406a include 4 buckets indexed 0-3 each corresponding to an index of uncompressed matrix 308a: NZ2:0 corresponds to index 0, NZ2:1 corresponds to index 1, NZ2:2 corresponds to index 2, and NZ2:3 corresponds to index 3. Thus, based on the second index value in metadata 304, the second nonzero of sparse matrix 302 (e.g., 3) can end up at index 0, index 1, index 2, or index 3 of uncompressed matrix 308a. Because the second index value of metadata 304 is 2, the second nonzero of sparse matrix 302 (e.g., 3) is assigned to the 2nd indexed bucket of nonzero 2 positions 406a and ends up at index 2 of uncompressed matrix 308a.

Nonzero 3 positions 408a include 4 buckets indexed 0-3 each corresponding to an index of uncompressed matrix 308a: NZ3:0 corresponds to index 4, NZ3:1 corresponds to index 5, NZ3:2 corresponds to index 6, and NZ3:3 corresponds to index 7. Thus, based on the third index value in metadata 304, the third nonzero of sparse matrix 302 (e.g., 5) can end up at index 4, index 5, index 6, or index 7 of uncompressed matrix 308a. Because the third index value of metadata 304 is 1, the third nonzero of sparse matrix 302 (e.g., 5) is assigned to the 1st indexed bucket of nonzero 3 positions 408a and ends up at index 5 of uncompressed matrix 308a.

Nonzero 4 positions 410a include 4 buckets indexed 0-3 each corresponding to an index of uncompressed matrix 308a: NZ4:0 corresponds to index 4, NZ4:1 corresponds to index 5, NZ4:2 corresponds to index 6, and NZ4:3 corresponds to index 7. Thus, based on the fourth index value in metadata 304, the fourth nonzero of sparse matrix 302 (e.g., 2) can end up at index 4, index 5, index 6, or index 7 of uncompressed matrix 308a. Because the fourth index value of metadata 304 is 3, the fourth nonzero of sparse matrix 302 (e.g., 2) is assigned to the 3rd indexed bucket of nonzero 4 positions 410a and ends up at index 7 of uncompressed matrix 308a.

FIG. 4B is an example block diagram of decompressing an expressive sparse matrix with limited metadata to an uncompressed matrix, according to at least one embodiment. Sparse matrix 302 and corresponding metadata 304 can be decompressed according to format 306b to obtain uncompressed matrix 308b. In some embodiments, format 306b can be known as an “alternating” format (e.g., N:M:P, alternating). Format 306b is represented with output indices 402b 0-7 and buckets corresponding to each of the possible positions for each nonzero of sparse matrix 302. For example, because format 306b corresponds to a 4:8:4,F (de) compression scheme, there are 4 rows of nonzero positions (e.g., 404b, 406b, 408b, and 410b) corresponding to the 4 nonzero elements of sparse matrix 302 (e.g., N=4 in N:M:P,F scheme). Each row of nonzero positions has 4 buckets corresponding to the 4 available positions for each nonzero (e.g., P=4 in N:M:P,F scheme).

Because the first index value of metadata 304 is 0, the first nonzero of sparse matrix 302 (e.g., 8) is assigned to the 0th indexed bucket of nonzero 1 positions 404b and ends up at index 0 of uncompressed matrix 308b. Because the second index value of metadata 304 is 2, the second nonzero of sparse matrix 302 (e.g., 3) is assigned to the 2nd indexed bucket of nonzero 2 positions 406b and ends up at index 6 of uncompressed matrix 308b. Because the third index value of metadata 304 is 1, the third nonzero of sparse matrix 302 (e.g., 5) is assigned to the 1st indexed bucket of nonzero 3 positions 408b and ends up at index 1 of uncompressed matrix 308b. Because the fourth index value of metadata 304 is 3, the fourth nonzero of sparse matrix 302 (e.g., 2) is assigned to the 3rd indexed bucket of nonzero 4 positions 410b and ends up at index 7 of uncompressed matrix 308b.

As demonstrated in FIG. 4B, in some embodiments, the order of nonzeros in sparse matrix 302 can be different than the order of the nonzeros in the uncompressed matrix (e.g., uncompressed matrix 308b) depending on the format used for the decompression.

FIG. 4C is an example block diagram of decompressing an expressive sparse matrix with limited metadata to an uncompressed matrix, according to at least one embodiment. Sparse matrix 302 and corresponding metadata 304 can be decompressed according to format 306c to obtain uncompressed matrix 308c. In some embodiments, format 306c can be known as a “direct” format (e.g., N:M:P, direct). Format 306c is represented with output indices 402c 0-7 and buckets corresponding to each of the possible positions for each nonzero of sparse matrix 302. For example, because format 306c corresponds to a 4:8:4,F (de) compression scheme, there are 4 rows of nonzero positions (e.g., 404c, 406c, 408c, and 410c) corresponding to the 4 nonzero elements of sparse matrix 302 (e.g., N=4 in N:M:P,F scheme). Each row of nonzero positions has 4 buckets corresponding to the 4 available positions for each nonzero (e.g., P=4 in N:M:P,F scheme).

Because the first index value of metadata 304 is 0, the first nonzero of sparse matrix 302 (e.g., 8) is assigned to the 0th indexed bucket of nonzero 1 positions 404c and ends up at index 0 of uncompressed matrix 308c. Because the second index value of metadata 304 is 2, the second nonzero of sparse matrix 302 (e.g., 3) is assigned to the 2nd indexed bucket of nonzero 2 positions 406c and ends up at index 3 of uncompressed matrix 308c. Because the third index value of metadata 304 is 1, the third nonzero of sparse matrix 302 (e.g., 5) is assigned to the 1st indexed bucket of nonzero 3 positions 408c and ends up at index 4 of uncompressed matrix 308c. Because the fourth index value of metadata 304 is 3, the fourth nonzero of sparse matrix 302 (e.g., 2) is assigned to the 3rd indexed bucket of nonzero 4 positions 410c and ends up at index 7 of uncompressed matrix 308c.

FIG. 4D is an example block diagram of decompressing an expressive sparse matrix with limited metadata to an uncompressed matrix, according to at least one embodiment. Sparse matrix 302 and corresponding metadata 304 can be decompressed according to format 306d to obtain uncompressed matrix 308d. In some embodiments, format 306d can be known as a “checkerboard” format (e.g., N:M:P, checkerboard). Format 306d is represented with output indices 402d 0-7 and buckets corresponding to each of the possible positions for each nonzero of sparse matrix 302. For example, because format 306d corresponds to a 4:8:4, F (de) compression scheme, there are 4 rows of nonzero positions (e.g., 404d, 406d, 408d, and 410d) corresponding to the 4 nonzero elements of sparse matrix 302 (e.g., N=4 in N:M:P,F scheme). Each row of nonzero positions has 4 buckets corresponding to the 4 available positions for each nonzero (e.g., P=4 in N:M:P,F scheme).

Because the first index value of metadata 304 is 0, the first nonzero of sparse matrix 302 (e.g., 8) is assigned to the 0th indexed bucket of nonzero 1 positions 404d and ends up at index 0 of uncompressed matrix 308d. Because the second index value of metadata 304 is 2, the second nonzero of sparse matrix 302 (e.g., 3) is assigned to the 2nd indexed bucket of nonzero 2 positions 406d and ends up at index 4 of uncompressed matrix 308d. Because the third index value of metadata 304 is 1, the third nonzero of sparse matrix 302 (e.g., 5) is assigned to the 1st indexed bucket of nonzero 3 positions 408d and ends up at index 3 of uncompressed matrix 308d. Because the fourth index value of metadata 304 is 3, the fourth nonzero of sparse matrix 302 (e.g., 2) is assigned to the 3rd indexed bucket of nonzero 4 positions 410d and ends up at index 7 of uncompressed matrix 308d.

Although 4 specific formats are shown here, it should be understood that other formats can be used during compression and/or decompression of dense/sparse matrices.

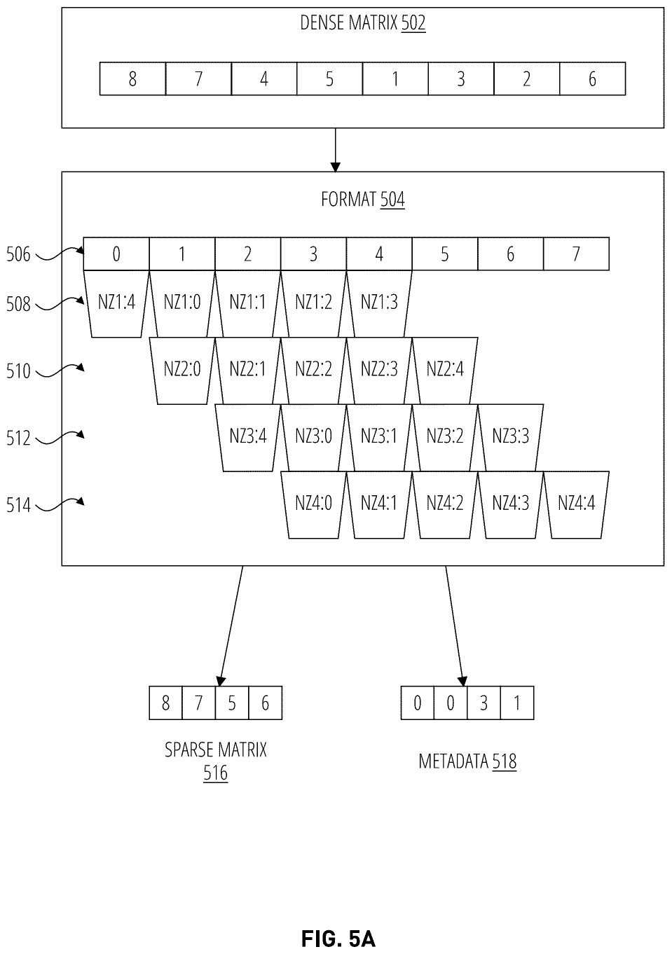

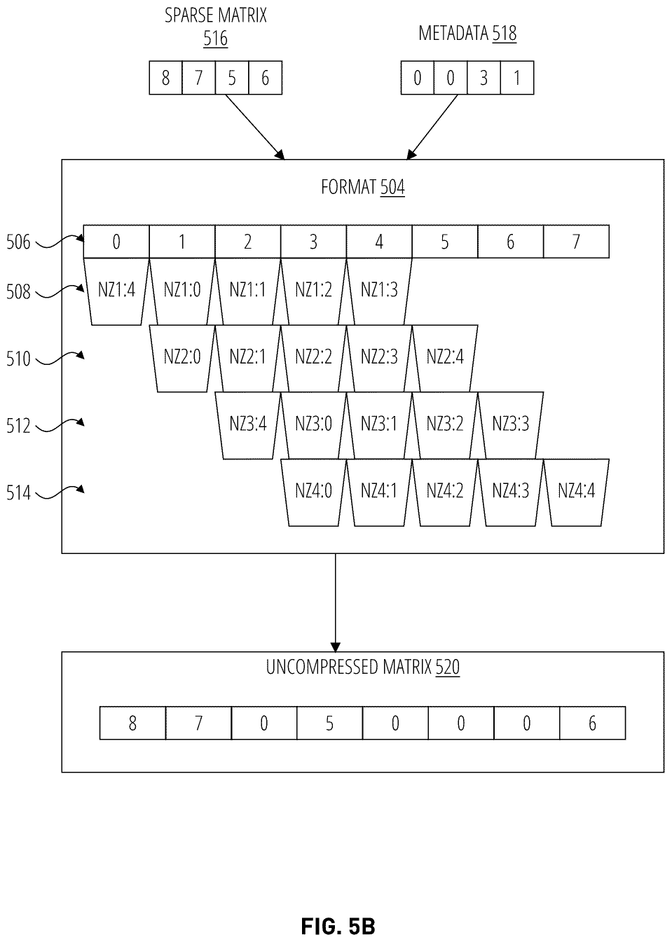

FIG. 5A is an example block diagram of compressing a dense matrix 502 to a fully-expressive sparse matrix 516 with limited metadata 518, according to at least one embodiment. To perform compression using the N:M:Bb scheme, a dense matrix can be received and/or identified. The dense matrix can include at least M consecutive elements. The dense matrix can have K nonzero elements. N of the M elements can be preserved during compression and can be included in the sparse matrix. The N elements of the resulting sparse matrix can be a subset of the K nonzero elements of the dense matrix.

In some embodiments, the N elements are selected from the K nonzero elements based on an importance value for each elements. For example, each of the K nonzero elements can be assigned an importance value based on an importance criterion (e.g., absolute magnitude, etc.). The N elements with the largest importance values can be selected from the K nonzero elements and can be included in sparse matrix 516.

The number of metadata bits B per nonzero in the N:M:Bb compression scheme used for compression determines how the dense matrix is expressed in the sparse matrix and corresponding metadata. Compressing a dense matrix using a 4:8:2b scheme will be discussed, but it should be understood that other N:M:Bb compression schemes can take advantage of the principles discussed herein.

Compressing a dense matrix using a 4:8:2b scheme means that 4 nonzeros of 8 consecutive elements of a dense matrix (e.g., dense matrix 502) can be preserved in the sparse matrix (e.g., sparse matrix 516), and each nonzero will have 2 bits of metadata representing an index of the nonzero in the dense matrix. In the given 4:8:2b compression scheme, each nonzero can have 5 available positions (e.g., nonzero 1 positions 508, nonzero 2 positions 510, nonzero 3 positions 512, nonzero 4 positions 514) as represented by format 504. The first and second nonzeros can be combined into a first group, and the third and fourth nonzeros can be combined into a second group. The first and second nonzeros can cover indices 0-5 of the 8 total indices 506 of the dense matrix (or of the uncompressed matrix during decompression). The third and fourth nonzeros can cover indices 2-7 of the 8 total indices 506 of the dense matrix (or of the uncompressed matrix during decompression). Discussion will focus on the first and second nonzeros, but the techniques can be applied in a similar manner to the third and fourth nonzeros.

4 of the 5 available positions for the first and second nonzeros can overlap and can cover indices 1-4 of the dense matrix. The 4 overlapping positions can share similar indices. For example, nonzero 1 positions 508 include 5 positions indexed 0-4: NZ1:4, NZ1:0, NZ1:1, NZ1:2, and NZ1:3. Nonzero 2 positions 510 include 5 positions also indexed 0-4: NZ1:0, NZ1:1, NZ1:2, NZ1:3, and NZ1:4. Indices 0-3 of nonzero 1 positions 508 and of nonzero 2 positions 510 both correspond to indices 1-4 of the dense matrix. Index 4 of nonzero 1 positions 508 can cover the index 0 of the dense matrix, while index 4 of nonzero 2 positions 510 can cover the index 5 of the dense matrix.

The indices of the elements with the highest importance value within indices 0-5 of dense matrix 502 can be determined. For example, the element in index 0 (e.g., 8) and the element in index 1 (e.g., 7) can be selected. Expressing those positions using nonzero 1 positions 508 and nonzero 2 positions 510 corresponds to metadata indices (4,0): index 0 of dense matrix 502 corresponds to index 4 of nonzero 1 positions 508 and index 1 of dense matrix 502 corresponds to index 0 of nonzero 2 positions 510. The index value “4” cannot be expressed as a metadata index using only 2 bits of metadata, so the metadata will need to be “packed” into 2 bits.

The metadata can be packed using the following rules that impose a structure on the metadata. For a given metadata index pair (A,B), if A is 4 and B is less than or equal to 1, A can be assigned the same value as B. For example, in the example above, the metadata indices are (4,0). That can be “packed” (e.g., converted, compressed, etc.) into the value (0,0) (since A=4 and B<=1, A=B=0).

For a given metadata index pair (A,B), if A is 4 and B is greater than or equal to 2, A can be incremented by 1 modulo 5 (to constrain the values between 0 and 4, inclusive), B can be decremented by 1 modulo 5, and A and B can switch positions. For example, if the metadata indices were (4,3), A can be incremented to 5 and “wrap around” (due to the modulo operator) to 0, B can be decremented to 2, and A and B can swap, resulting in the “packed” metadata index pair (2,0).

For a given metadata index pair (A,B), if A is not 4 and B is 4, and if A is greater than or equal to 2, B can be assigned the same value as A. For example, if the metadata indices were (2,4), B can be assigned the same value as A, resulting in the metadata indices (2,2).

For a given metadata index pair (A,B), if A is not 4 and B is 4, and if A is less than or equal to 1, A can be incremented by 1 modulo 5, B can be decremented by 1 modulo 5, and A and B can switch positions. For example, if the metadata indices were (1,4), A can be incremented to 2, B can be decremented to 3, and A and B can swap, resulting in the “packed” metadata index pair (3,2).

In the above cases, the metadata index pair can be “packed” before being stored with the sparse matrix. In any other case, the metadata index pair (A,B) can be stored without being modified. When the sparse matrix and corresponding metadata are accessed (e.g., for decompression or during sparse matrix math operations), the metadata can be “unpacked” if necessary. The “packing” scheme discussed above can make it easy to determine whether the metadata was originally packed or not. See FIG. 5B below for an example of decompression.

The above metadata packing rules can be expressed by the following pseudocode:

```
For a pair of indices (A,B)
If A == 4:
  If B <= 1: set A to B
  If B >= 2: ++A mod 5, −−B mod 5, swap(A,B)
Else if B == 4:
  If A >= 2: set B to A
  If A <= 1: ++A mod 5, −−B mod 5, swap(A,B)
```

In the example depicted in FIG. 5A, dense matrix 502 is compressed using a 4:8:2b compression scheme. The 4 elements with the largest values (e.g., 8 in index 0, 7 in index 1, 5 in index 3, and 6 in index 7) are compressed into sparse matrix 516 with corresponding metadata 518. As discussed above, the first 2 selected nonzeros to compress (e.g., 8 and 7) have corresponding metadata indices 4 and 0, respectively (based on their corresponding available nonzero positions (e.g., nonzero 1 positions 508 and nonzero 2 positions 510)). The metadata pair (4,0) can be “packed” according to the rules above into the pair (0,0) for storage, as shown by the first two elements of metadata 518.

The next 2 selected nonzero to compress (e.g., 5 and 6) have corresponding metadata indices 0 and 4, respectively (based on their corresponding available nonzero positions (e.g., nonzero 3 positions 512 and nonzero 4 positions 514)). The metadata pair (0,4) can be “packed” according to the rules above into the pair (3,1) for storage, as shown by the last two elements of metadata 518. The example depicted in FIG. 5B will go through decompressing sparse matrix 516 and metadata 518 to obtain an uncompressed matrix (e.g., uncompressed matrix 520) that corresponds to dense matrix 502.

The above metadata unpacking rules can be expressed by the following pseudocode:

```
For a pair of indices (A,B)
If A < B: do not modify
If A == B:
  If A <= 1: set A to 4
  If A >= 2: set B to 4
If A > B: swap(A,B), −−A mod 5, ++B mod 5
```

In the example depicted in FIG. 5B, sparse matrix 516 and corresponding metadata 518 are decompressed using a 4:8:2b decompression scheme. The 4 nonzero elements of sparse matrix 516 (e.g., 8, 7, 5, and 6) are decompressed into uncompressed matrix 520. As discussed above, the first two metadata index values (e.g., 0 and 0) can be evaluated as a pair (0,0), which can be “unpacked” according to the rules above into the pair (4,0). Thus, the first nonzero of sparse matrix 516 (e.g., 8) can be assigned to index 4 of nonzero 1 positions 508, which corresponds to index 0 of uncompressed matrix 520, and the second nonzero of sparse matrix 516 (e.g., 7) can be assigned to index 0 of nonzero 2 positions 510, which corresponds to index 1 of uncompressed matrix 520.

The next two metadata index values (e.g., 3 and 1) can be evaluated as a pair (3,1), which can be “unpacked” according to the rules above into the pair (0,4). Thus, the third nonzero of sparse matrix 516 (e.g., 5) can be assigned to index 0 of nonzero 3 positions 512, which corresponds to index 3 of 520, and the fourth nonzero of sparse matrix 516 (e.g., 6) can be assigned to index 4 of nonzero 4 positions 514, which corresponds to index 7 of uncompressed matrix 520.

In some embodiments, during compression and/or decompression, nonzero elements and/or metadata index values can be evaluated more than 2 at a time (e.g., in a group of 3, in a group of 4, etc.).

FIG. 5B is an example block diagram of decompressing a fully-expressive sparse matrix 516 with limited metadata 518 to an uncompressed matrix 520, according to at least one embodiment. Sparse matrix 516 and corresponding metadata 518 can be the result of compressing dense matrix 502 of FIG. 5A. To perform decompression using the N:M:Bb scheme, a sparse matrix and corresponding metadata can be received and/or identified. The sparse matrix can include N nonzero elements and can be decompressed into a M element matrix.

Decompressing a sparse matrix using a 4:8:2b scheme will be discussed, but it should be understood that other N:M:Bb decompression schemes can take advantage of the principles discussed herein.

Sparse matrix 516 and corresponding metadata 518 can be decompressed to obtain uncompressed matrix 520. Uncompressed matrix 520 can include the N nonzero elements from sparse matrix 516 and M-N other elements (e.g., zero value elements, random value elements, etc.).

In the given 4:8:2b decompression scheme, each nonzero can have 5 available positions (e.g., nonzero 1 positions 508, nonzero 2 positions 510, nonzero 3 positions 512, nonzero 4 positions 514). The first and second nonzeros can be combined into a first group, and the third and fourth nonzeros can be combined into a second group. The metadata values can correspond to indices within the available positions for the corresponding set of nonzero positions. As discussed above, some of the metadata values can be “packed” to express nonzeros in index 4 of one of the nonzero positions. When the metadata is packed according to the rules discussed in relation to FIG. 5A, the metadata values can be “unpacked” according to the following rules.

As discussed above, metadata indices can be evaluated in pairs. For a given metadata index pair (A,B,), if A is less than B, the metadata may not need to be unpacked, and the indices correspond directly to the corresponding nonzero position index. For example, given the metadata index pair (1,3) for the first 2 nonzeros of the sparse matrix, the first nonzero of the sparse matrix can be assigned to index 2 of the uncompressed matrix because index 1 of nonzero 1 positions 508 corresponds to index 2 of the uncompressed matrix, and the second nonzero of the sparse matrix can be assigned to index 4 of the uncompressed matrix because index 3 of nonzero 2 positions 510 corresponds to index 4 of the uncompressed matrix.

For a given metadata index pair (A,B), if A is equal to B and A is less than or equal to 1, the A index can be set to 4. For example, the “packed” metadata index pair (1,1) can be “unpacked” into (4,1). This can mean that the first nonzero of the sparse matrix can be assigned to index 0 of the uncompressed matrix because index 4 of nonzero 1 positions 508 corresponds to index 0 of the uncompressed matrix and the second nonzero of the sparse matrix can be assigned to index 2 of the uncompressed matrix because index 1 of nonzero 2 positions 510 corresponds to index 2 of the uncompressed matrix.

For a given metadata index pair (A,B), if A is equal to B and A is greater than or equal to 2, the B index can be set to 4. For example, the “packed” metadata index pair (3,3) can be “unpacked” into (3,4). This can mean that the first nonzero of the sparse matrix can be assigned to index 4 of the uncompressed matrix because index 3 of nonzero 1 positions 508 corresponds to index 4 of the uncompressed matrix and the second nonzero of the sparse matrix can be assigned to index 5 of the uncompressed matrix because index 4 of nonzero 2 positions 510 corresponds to index 5 of the uncompressed matrix.

For a given metadata index pair (A,B), if A is greater than B, A and B can be swapped, the new A can be decremented by 1 modulo 5, and the new B can be incremented by 1 modulo 5. For example, the “packed” metadata index pair (2,0) can be “unpacked” into (4,3) by swapping 2 and 0, decrementing 0 by 1 and “wrapping around” to 4 (as a result of the modulo operator), and incrementing 2 to 3. This can mean that the first nonzero of the sparse matrix can be assigned to index 0 of the uncompressed matrix because index 4 of nonzero 1 positions 508 corresponds to index 0 of the uncompressed matrix and the second nonzero of the sparse matrix can be assigned to index 4 of the uncompressed matrix because index 3 of nonzero 2 positions 510 corresponds to index 4 of the uncompressed matrix.

The same rules can be applied to the second pair of metadata values in metadata 518. Thus, if the A index of a metadata index pair (A,B) is greater than or equal to the B index, the metadata values can be unpacked, otherwise they may not need to be modified. These (un) packing rules can be based on the following principles: 1) having two metadata indices that correspond to the same dense matrix index (or uncompressed matrix index) is redundant, and 2) the metadata pair (0,1) is equivalent to the metadata pair (1,0). Thus, with regard to the first principle, it can be decided that metadata indices with the same value can be given special meaning. And with regard to the second principle, a decision can be made that metadata index values in ascending (or descending) order can be applied directly and metadata index values in descending (or ascending) order can be given special meaning. Thus, when the metadata indices are the same or when A is greater than or equal to B (e.g., the metadata index values are in descending order), special meaning can be applied (as demonstrated by the rules above).

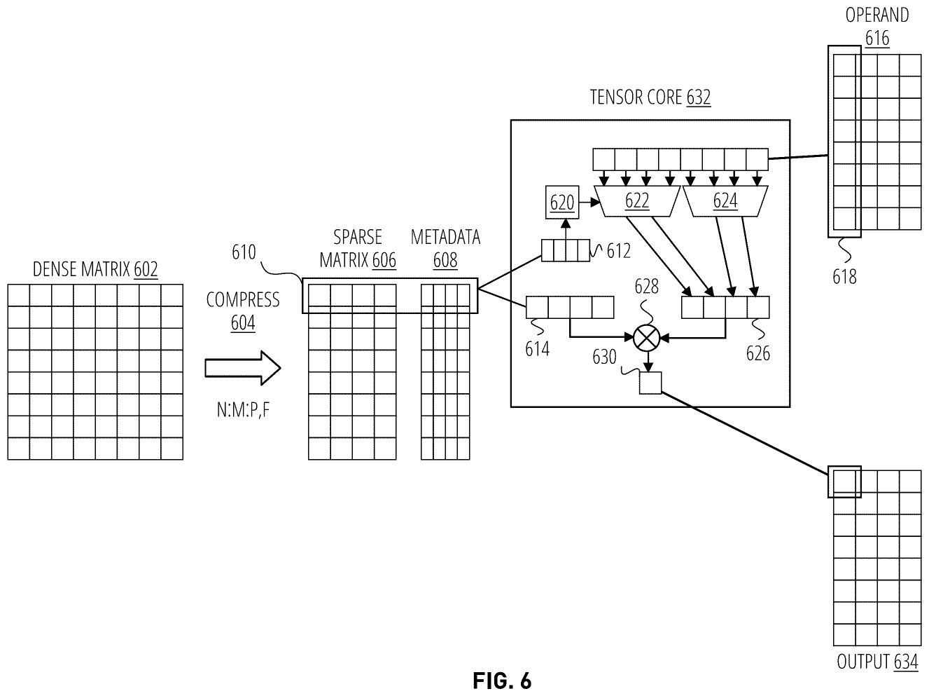

FIG. 6 is an example block diagram of computing a dot-product between a sparse matrix 606 with corresponding metadata 608 and a matrix operand 616, according to at least one embodiment. Dense matrix 602 can be converted into sparse matrix 606 and corresponding metadata 608 using compress 604 according to a given N:M:P,F compression scheme and/or a given N:M:Bb compression scheme. In some embodiments, compress 604 is performed by sparse matrix subsystem 106 of FIG. 1. Sparse matrix 606 and metadata 608 can include a plurality of elements. A subset of the elements of sparse matrix 606 and metadata 608 (e.g., sparse matrix row 610) can be provided to tensor core 632. In some embodiments, the subset of elements from sparse matrix 606 and metadata 608 can be a column of elements or some other subset of elements of sparse matrix 606 and corresponding metadata 608.

Tensor core 632 can perform one or more matrix math operations on sparse matrix row 610. For example, tensor core 632 can receive a subset of elements from operand 616 (e.g., operand column 618). In some embodiments, the subset of elements from operand 616 can be a row of elements or some other subset of elements of operand 616. In some embodiments, tensor core 632 can be comprised within a central processing unit (CPU) or a graphics processing unit (GPU).

Tensor core 632 can include control circuit 620 and one or more selection circuits (e.g., selector 622, selector 624). Control circuit 620 can receive sparse matrix row metadata 612 and can convert the index values of sparse matrix row metadata 612 into control signals for the one or more selection circuits. In some embodiments, selector 622 and/or selector 624 can be a multiplexer. For example, selector 622 and selector 624 can each be a 4:2 multiplexer. In some embodiments, a single 8:4 multiplexer can be used. In some embodiments, 4 8:1 multiplexers can be used, or any other combination that produces 4 output values. In some embodiments, 4 5:1 multiplexers can be used for a 4:8:2b (de) compression scheme.

Selector 622 and selector 624 can select a subset of operand column 618 based on sparse matrix row metadata 612 (e.g., based on the control signals control circuit 620 generated based on sparse matrix row metadata 612). For example, sparse matrix row metadata 612 can include indices of operand column 618 that should be preserved. In some embodiments, control circuit 620 can modify (e.g., bit shift, add to, subtract from, etc.) one or more values of sparse matrix row metadata 612 before providing the values to selector 622 and/or selector 624. For example, in some embodiments, one or more values of sparse matrix row metadata 612 can be “unpacked” according to the rules discussed in relation to FIG. 5B above before being provided to selector 622 and/or selector 624. In some embodiments, selector 622 and/or selector 624 can be configured to select elements of operand column 618 according to a predetermined compression scheme format (e.g., replicated, alternating, direct, checkerboard, etc.). The output of selector 622 and/or selector 624 can be operand column subset 626, which can be used as an operand in dot-product 628. The other operand of dot-product 628 can be sparse matrix row values 614. Dot-product 628 can compute the dot-product between sparse matrix row values 614 and operand column subset 626 to obtain dot-product result 630. Dot-product result 630 can be included in output 634 based on an index of sparse matrix row 610 within sparse matrix 606 and an index of operand column 618 within operand 616.

In some embodiments, selector 622 and/or selector 624 can be select a subset of elements from operand column 618 according to more than one compression scheme format. For example, in some embodiments, a format indicator can be included in metadata 608 during compress 604. Selector 622 and/or selector 624 can be configured to interpret the index values of metadata 608 differently based on the format indicator in metadata 608.

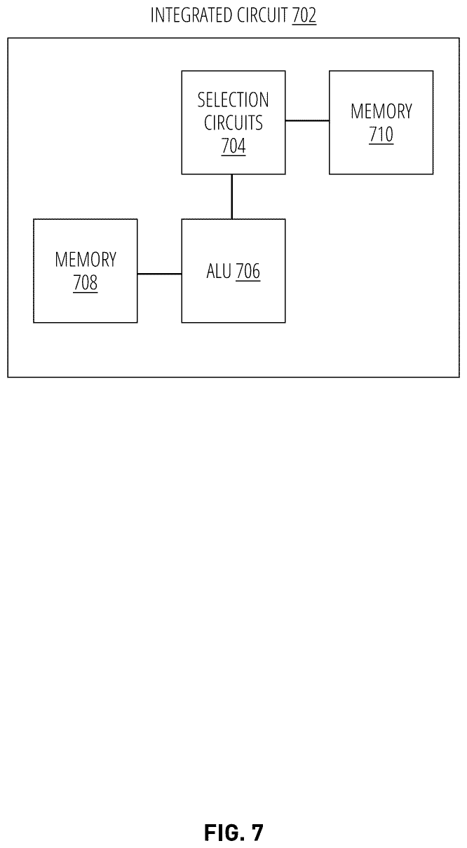

FIG. 7 is an example block diagram of an integrated circuit 702 for performing matrix math operations using a sparse matrix with corresponding metadata, according to at least one embodiment. Integrated circuit 702 can include selection circuits 704, an arithmetic logic unit (ALU) 706, memory 708, and memory 710. In some embodiments, selection circuits 704 can include one or more multiplexers for selecting a subset of input values based on a selector value. Selection circuits 704 can be coupled to memory 710. In some embodiments, integrated circuit 702 includes more than one ALU (e.g., two arithmetic logic units (ALUs)). In some embodiments, operands can be stored in memory 710. In some embodiments, selection circuits 704 can include a control circuit that causes the one or more multiplexers to select elements of the matrix operand based on the indices included in metadata that is also provided to selection circuits 704. For example, the metadata can include an index for each of the N nonzero elements from the dense matrix, and selection circuits 704 can select a subset of elements from an operand based on the indices. Selection circuits 704 can also be coupled to ALU 706. ALU 706 can be capable of performing one or more math operations on given inputs. For example, ALU 706 can perform one or more matrix math operations (e.g., dot-product). In some embodiments, ALU 706 can be coupled to memory 708, which can store one or more dense matrices, sparse matrices, and/or corresponding metadata.

In some embodiments, integrated circuit 702 can be part of a tensor core circuit of a processor. In some embodiments, the processor is a central processing unit (CPU) or a graphics processing unit (GPU).

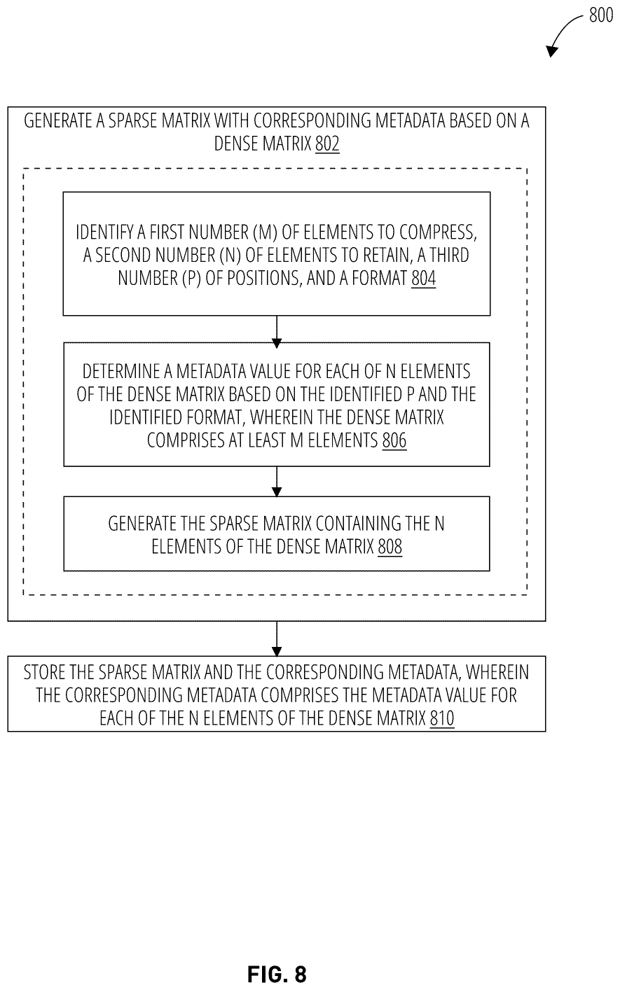

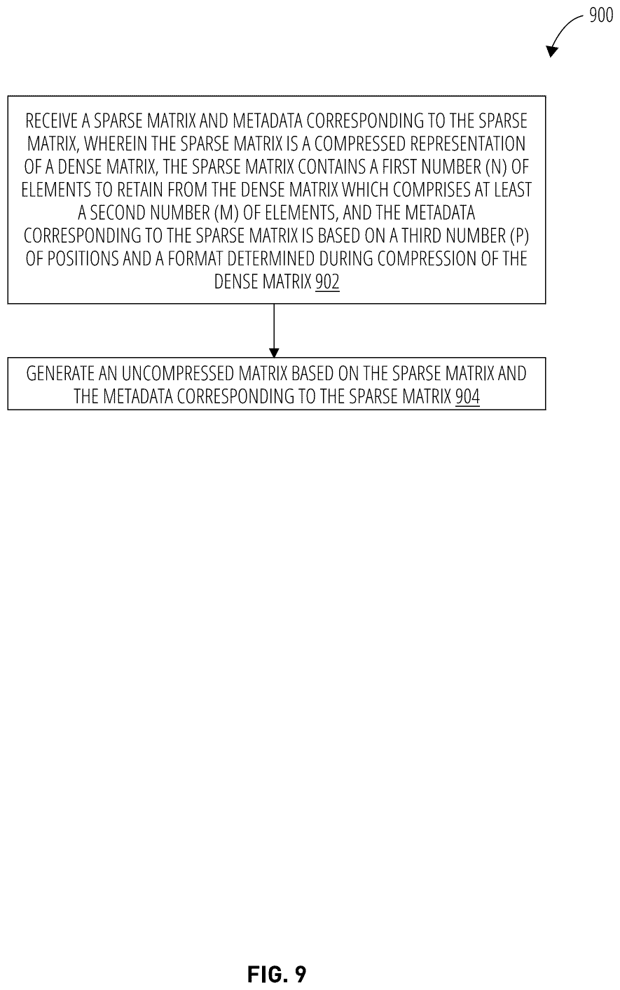

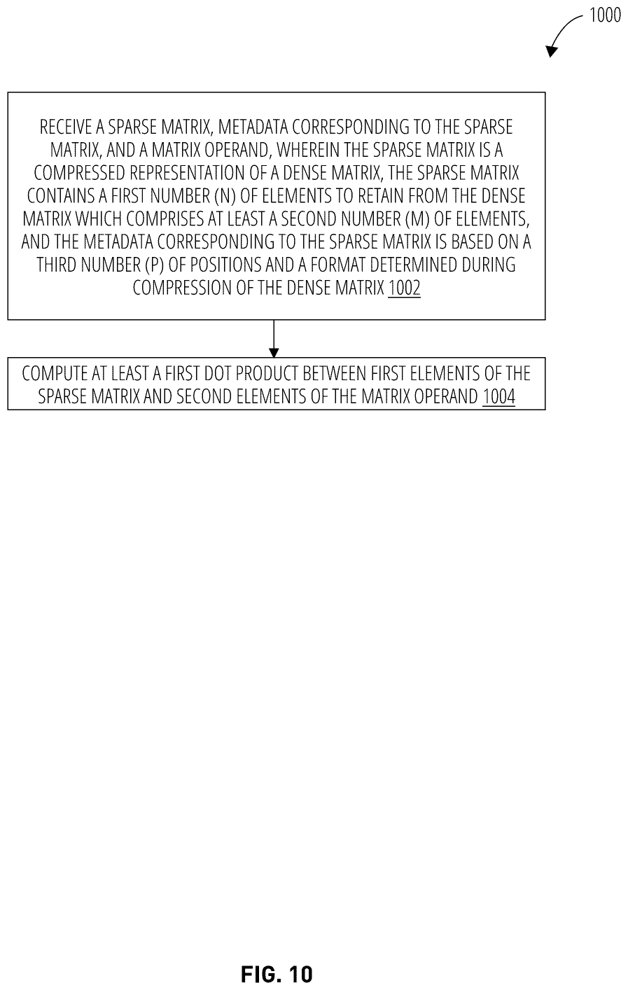

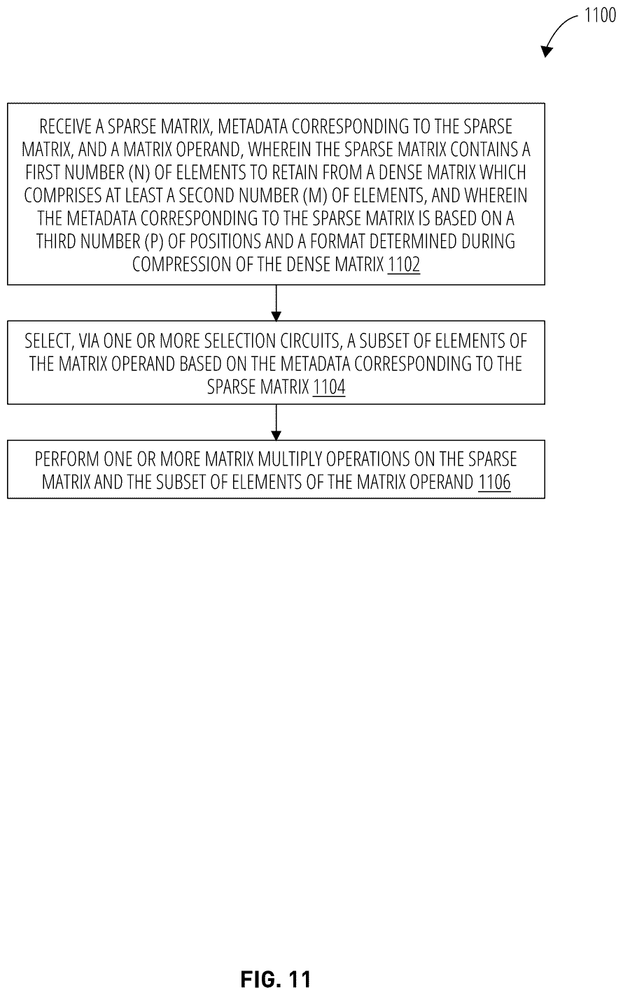

FIG. 8 is a flow diagram of an example method 800 for compressing a dense matrix to an expressive sparse matrix with limited metadata, according to at least one embodiment. FIG. 9 is a flow diagram of an example method 900 for decompressing an expressive sparse matrix with limited metadata to an uncompressed matrix, according to at least one embodiment. FIG. 10 is a flow diagram of an example method 1000 for computing a dot product using an expressive sparse matrix with limited metadata, according to at least one embodiment. FIG. 11 is a flow diagram of an example method 1100 for performing matrix multiply operations using an expressive sparse matrix with limited metadata, according to at least one embodiment.

Methods 800, 900, 1000, and/or 1100 can be performed using one or more processing units (e.g., CPUs, GPUs, accelerators, physics processing units (PPUs), data processing units (DPUs), etc.), which may include (or communicate with) one or more memory devices. In at least one embodiment, methods 800, 900, 1000, and/or 1100 can be performed using a processing device or processing devices. In at least one embodiment, methods 800 and/or 900 can be performed using processing units of system 102 of FIG. 1. In at least one embodiment, methods 1000 and/or 1100 can be performed by tensor core 632 of FIG. 6 and/or integrated circuit 702 of FIG. 7. In at least one embodiment, processing units performing any of methods 800, 900, 1000, and/or 1100 can be executing instructions stored on a non-transient computer readable storage media. In at least one embodiment, any of methods 800, 900, 1000, and/or 1100 can be performed using multiple processing threads (e.g., CPU threads and/or GPU threads), individual threads executing one or more individual functions, routines, subroutines, or operations of the method. In at least one embodiment, processing threads implementing any of methods 800, 900, 1000, and/or 1100 can be synchronized (e.g., using semaphores, critical sections, and/or other thread synchronization mechanisms). Alternatively, processing threads implementing any of methods 800, 900, 1000, and/or 1100 can be executed asynchronously with respect to each other. Various operations of methods 800, 900, 1000, and/or 1100 can be performed in a different order compared with the order shown in FIG. 8, FIG. 9, FIG. 10, and/or FIG. 11. Some operations of any of methods 800, 900, 1000, and/or 1100 can be performed concurrently with other operations. In at least one embodiment, one or more operations shown in FIG. 8, FIG. 9, FIG. 10, and/or FIG. 11 may not always be performed.

FIG. 8 is a flow diagram of an example method 800 for compressing a dense matrix to an expressive sparse matrix with limited metadata, according to at least one embodiment. Processing units executing method 800 can, at block 802, generate a sparse matrix with corresponding metadata based on a dense matrix. In some embodiments, to generate the sparse matrix with corresponding metadata, the processing units can, at block 804, identify a first number (M) of elements to compress, a second number (N) of elements to retain, a third number (P) of positions, and a format. In some embodiments, P is less than M. At block 806, the processing units can determine a metadata value for each of N elements of the dense matrix based on the identified P and the identified format. The dense matrix can include at least M elements. At block 808, the processing units can generate the sparse matrix containing the N elements of the dense matrix. At block 810, processing units executing method 800 can store the sparse matrix and the corresponding metadata.

The corresponding metadata can include the metadata value for each of the N elements of the dense matrix. In some embodiments, the metadata value for each of the N elements of the dense matrix indicates an index corresponding to one of P positions associated with the identified format. In some embodiments, the sparse matrix is stored alongside the corresponding metadata in memory. In some embodiments, the sparse matrix is stored in a separate memory location from the corresponding metadata.

In some embodiments, processing units can further identify a fourth number (K) of nonzero elements of the dense matrix and identify the N elements of the dense matrix from the K elements based on an importance criterion. In some embodiments, to identify the N elements of the dense matrix based on the importance criterion, processing units can select the N elements of the dense matrix that maximize an importance value of the sparse matrix. In some embodiments, processing units can further decompress the sparse matrix to obtain an uncompressed sparse matrix having at least the N elements of the dense matrix. In some embodiments, to decompress the sparse matrix to obtain the uncompressed sparse matrix, the processing units can initialize a matrix having M elements and assign values to N elements of the matrix based on the sparse matrix and the corresponding metadata. The corresponding metadata can indicate, based on the identified P and identified format, where each value of the sparse matrix appears in the matrix.

FIG. 9 is a flow diagram of an example method 900 for decompressing an expressive sparse matrix with limited metadata to an uncompressed matrix, according to at least one embodiment. Processing units executing method 900 can, at block 902, receive a sparse matrix and metadata corresponding to the sparse matrix. The sparse matrix can be a compressed representation of a dense matrix. The sparse matrix can contain a first number (N) of elements to retain from the dense matrix which can include at least a second number (M) of elements. The metadata corresponding to the sparse matrix can be based on a third number (P) of positions and a format determined during compression of the dense matrix. In some embodiments, P is less than M. At block 904, processing units can generate an uncompressed matrix based on the sparse matrix and the metadata corresponding to the sparse matrix. In some embodiments, the metadata corresponding to the sparse matrix can include an index for each of the N elements to retain from the dense matrix. The index can correspond to one of the P positions associated with the format determined during compression of the dense matrix.

In some embodiments, the dense matrix can include a fourth number (K) of nonzero elements and the N elements to retain from the dense matrix represent a subset of the K nonzero elements. In some embodiments, the uncompressed matrix based on the sparse matrix and the metadata corresponding to the sparse matrix can include at least the N elements of the dense matrix. In some embodiments, the uncompressed matrix based on the sparse matrix and the metadata corresponding to the sparse matrix can include M elements. In some embodiments, the processing units executing method 900 can further perform one or more matrix multiply operations on the uncompressed matrix based on the sparse matrix and the metadata corresponding to the sparse matrix and a matrix operand.

FIG. 10 is a flow diagram of an example method 1000 for computing a dot product using an expressive sparse matrix with limited metadata, according to at least one embodiment. Processing units executing method 1000 can, at block 1002, receive a sparse matrix, metadata corresponding to the sparse matrix, and a matrix operand. The sparse matrix can be a compressed representation of a dense matrix. The sparse matrix can contain a first number (N) of elements to retain from the dense matrix which can include at least a second number (M) of elements. The metadata corresponding to the sparse matrix can be based on a third number (P) of positions and a format determined during compression of the dense matrix. In some embodiments, P is less than M. At block 1004, processing units can compute at least a first dot product between first elements of the sparse matrix and second elements of the matrix operand. In some embodiments, the metadata corresponding to the sparse matrix includes an index for each of the N elements to retain from the dense matrix. In some embodiments, the index can correspond to one of the P positions associated with the format determined during compression of the dense matrix.

In some embodiments, to compute at least the first dot product between the first elements of the sparse matrix and the second elements of the matrix operand, the processing units can select a subset of elements of the matrix operand based on the index for each of the N elements to retain of the dense matrix, the subset of elements being the second elements of the matrix operand. In some embodiments, the dense matrix can include a fourth number (K) of nonzero elements, and the N elements to retain from the dense matrix can represent a subset of the K nonzero elements. In some embodiments, the N elements to retain of the dense matrix are identified based on an importance value of each of the M elements. In some embodiments, the sparse matrix is stored in a separate memory location from the metadata corresponding to the sparse matrix.

FIG. 11 is a flow diagram of an example method 1100 for performing matrix multiply operations using an expressive sparse matrix with limited metadata, according to at least one embodiment. Processing units executing method 1100 can, at block 1102, receive a sparse matrix, metadata corresponding to the sparse matrix, and a matrix operand. The sparse matrix can include at first number (N) of elements to retain from a dense matrix which can include at least a second number (M) of elements. The metadata corresponding to the sparse matrix can be based on a third number (P) of positions and a format determined during compression of the dense matrix. In some embodiments, P is less than M. At block 1104, processing units can select, via one or more selection circuits, a subset of elements of the matrix operand based on the metadata corresponding to the sparse matrix. At block 1106, processing units can perform one or more matrix multiply operations on the sparse matrix and the subset of elements of the matrix operand.

In some embodiments, method 1100 can be performed by integrated circuit 702 of FIG. 7. In some embodiments, the metadata corresponding to the sparse matrix can include an index for each of the N elements to retain from the dense matrix. The index can correspond to one of the P positions associated with the format determined during compression of the dense matrix. In some embodiments, the dense matrix can include a fourth number (K) of nonzero elements, and the N elements to retain from the dense matrix can represent a subset of the K nonzero elements. In some embodiments, the N elements to retain of the dense matrix are identified based on an importance value of each of the M elements. In some embodiments, the sparse matrix is stored in a separate memory location from the metadata corresponding to the sparse matrix.

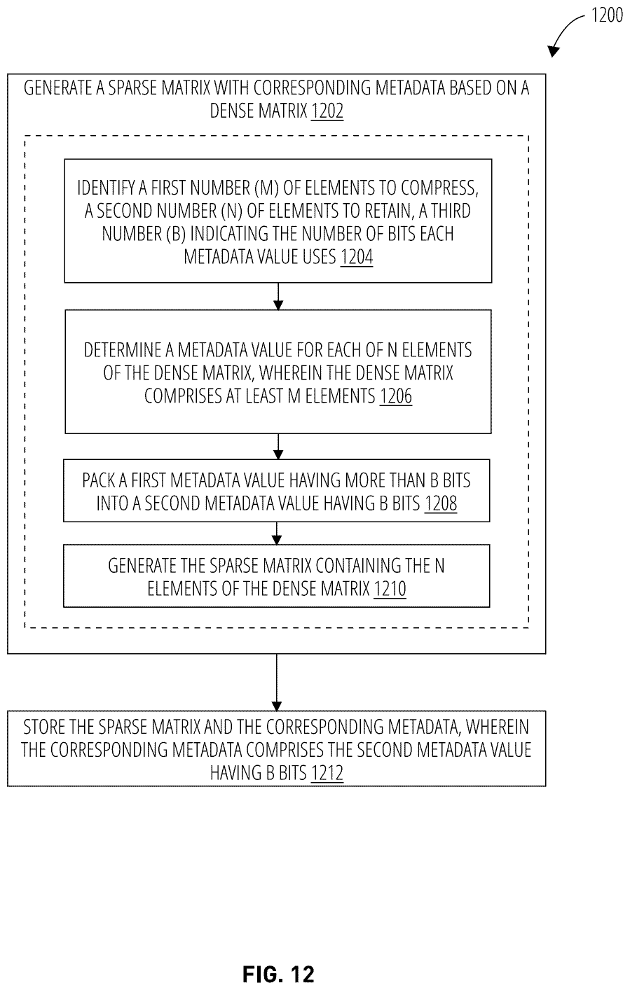

FIG. 12 is a flow diagram of an example method 1200 for compressing a dense matrix to a fully-expressive sparse matrix with limited metadata, according to at least one embodiment. Processing units executing method 1200 can, at block 1202, generate a sparse matrix with corresponding metadata based on a dense matrix. In some embodiments, to generate the sparse matrix with corresponding metadata, the processing units can, at block 1204, identify a first number (M) of elements to compress, a second number (N) of elements to retain, a third number (B) indicating the number of bits each metadata value uses. At block 1206, the processing units can determine a metadata value for each of N elements of the dense matrix. The dense matrix can include at least M elements. At block 1208, the processing units can pack a first metadata value having more than B bits into a second metadata value having B bits. At block 1210, the processing units can generate the sparse matrix containing the N elements of the dense matrix. At block 1212, processing units executing method 1200 can store the sparse matrix and the corresponding metadata.

The corresponding metadata can include the second metadata value having B bits. In some embodiments, the metadata value for each of the N elements of the dense matrix indicates an index corresponding to one of a number of positions available for each of the N elements of the dense matrix. In some embodiments, the sparse matrix is stored alongside the corresponding metadata in memory. In some embodiments, the sparse matrix is stored in a separate memory location from the corresponding metadata.

In some embodiments, processing units can further identify a fourth number (K) of nonzero elements of the dense matrix and identify the N elements of the dense matrix from the K elements based on an importance criterion. In some embodiments, to identify the N elements of the dense matrix based on the importance criterion, processing units can select the N elements of the dense matrix that maximize an importance value of the sparse matrix. In some embodiments, processing units can further decompress the sparse matrix to obtain an uncompressed sparse matrix having at least the N elements of the dense matrix. In some embodiments, to decompress the sparse matrix to obtain the uncompressed sparse matrix, the processing units can initialize a matrix having M elements, unpack the second metadata value having B bits into the first metadata value having more than B bits, and assign a value to a first element of the matrix based on the sparse matrix and the first metadata value having more than B bits.

Although the M elements to compress of the dense matrix have been described, in some embodiments, as consecutive elements, in other embodiments, the M elements of the dense matrix are not consecutive. For example, the M elements to compress of a dense matrix can be every other element, every third element, etc.

Although the N elements to retain of the dense matrix have been described, in some embodiments, as nonzero elements, in other embodiments, the N elements of the dense matrix include at least one zero value element. For example, the N elements to retain of a dense matrix can be all zeros. Similarly, although the P positions have been described, in some embodiments, as being nonzero positions, in other embodiments, the P positions are positions available for each of the N elements to retain, whether or not a particular element is nonzero.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two but can be more when so indicated either explicitly or by context. Further, unless stated otherwise or otherwise clear from context, the phrase “based on” means “based at least in part on” or “based at least on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, in some embodiments, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
generating a sparse matrix with corresponding metadata based on a dense matrix, wherein generating the sparse matrix with corresponding metadata comprises:
identifying a first number (M) of elements to compress, a second number (N) of elements to retain, a third number (P) of positions, and a format;
determining a metadata value for each of N elements of the dense matrix based on the identified P and the identified format, wherein the dense matrix comprises at least M elements; and
generating the sparse matrix containing the N elements of the dense matrix; and
storing the sparse matrix and the corresponding metadata, wherein the corresponding metadata comprises the metadata value for each of the N elements of the dense matrix.

2. The method of claim 1, wherein P is less than M.

3. The method of claim 1, wherein the metadata value for each of the N elements of the dense matrix indicates an index corresponding to one of P positions associated with the identified format.

4. The method of claim 1, wherein the sparse matrix is stored alongside the corresponding metadata.

5. The method of claim 1, wherein the sparse matrix is stored in a separate memory location from the corresponding metadata.

6. The method of claim 1, further comprising:
identifying a fourth number (K) of nonzero elements of the dense matrix; and
identifying the N elements of the dense matrix from the K elements based on an importance criterion.

7. The method of claim 6, wherein identifying the N elements of the dense matrix based on the importance criterion comprises selecting the N elements of the dense matrix that maximize an importance value of the sparse matrix.

8. The method of claim 1, further comprising decompressing the sparse matrix to obtain an uncompressed sparse matrix, the uncompressed sparse matrix having at least the N elements of the dense matrix.

9. The method of claim 8, wherein decompressing the sparse matrix to obtain the uncompressed sparse matrix comprises:
initializing a matrix having M elements; and
assigning values to N elements of the matrix based on the sparse matrix and the corresponding metadata, wherein the corresponding metadata indicates, based on the identified P and identified format, where each value of the sparse matrix appears in the matrix.

10. A system comprising:
a memory; and
a processor, coupled to the memory, to perform operations comprising:
generating a sparse matrix with corresponding metadata based on a dense matrix, wherein generating the sparse matrix with corresponding metadata comprises:
identifying a first number (M) of elements to compress, a second number (N) of elements to retain, a third number (P) of positions, and a format;
determining a metadata value for each of N elements of the dense matrix based on the identified P and the identified format, wherein the dense matrix comprises at least M elements; and
generating the sparse matrix containing the N elements of the dense matrix; and
storing the sparse matrix and the corresponding metadata, wherein the corresponding metadata comprises the metadata value for each of the N elements of the dense matrix.

11. The system of claim 10, wherein P is less than M.

12. The system of claim 10, wherein the metadata value for each of the N elements of the dense matrix indicates an index corresponding to one of P positions associated with the identified format.

13. The system of claim 10, wherein the sparse matrix is stored alongside the corresponding metadata.

14. The system of claim 10, wherein the sparse matrix is stored in a separate memory location from the corresponding metadata.

15. The system of claim 10, the operations further comprising:
identifying a fourth number (K) of nonzero elements of the dense matrix; and
identifying the N elements of the dense matrix from the K elements based on an importance criterion.

16. The system of claim 15, wherein identifying the N elements of the dense matrix based on the importance criterion comprises selecting the N elements of the dense matrix that maximize an importance value of the sparse matrix.

17. The system of claim 10, the operations further comprising decompressing the sparse matrix to obtain an uncompressed sparse matrix, the uncompressed sparse matrix having at least the N elements of the dense matrix.

18. The system of claim 17, wherein decompressing the sparse matrix to obtain the uncompressed sparse matrix comprises:
initializing a matrix having M elements; and
assigning values to N elements of the matrix based on the sparse matrix and the corresponding metadata, wherein the corresponding metadata indicates, based on the identified P and identified format, where each value of the sparse matrix appears in the matrix.

19. A processor comprising one or more processing units to:
generate a sparse matrix with corresponding metadata based on a dense matrix, wherein to generate the sparse matrix with corresponding metadata, the one or more processing units are further to:
identify a first number (M) of elements to compress, a second number (N) of elements to retain, a third number (P) of positions, and a format;
determine a metadata value for each of N elements of the dense matrix based on the identified P and the identified format, wherein the dense matrix comprises at least M elements; and
generate the sparse matrix containing the N elements of the dense matrix; and
store the sparse matrix and the corresponding metadata, wherein the corresponding metadata comprises the metadata value for each of the N elements of the dense matrix.

20. The processor of claim 19, wherein P is less than M.
